(19) United States
(12) Patent Application Publication
(10) Pub. No.: US 2005/0124387 A1
(43) Pub. Date: Jun. 9, 2005

(54) Portable apparatus user interface

(76) Inventors: Claudio Santiago Ribeiro, Evanston, IL (US); Iulius Lucaci, Evanston, IL (US); Paul M. Pierce, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 10/731,490

(22) Filed: Dec. 9, 2003

(51) Int. Cl. H04B 1/08

(52) U.S. Cl. 455/566; 455/575.1; 455/351

(57) ABSTRACT

The portable electronic apparatus includes a housing (202) having a keypad (206), a rotary input device (204), a display (208), a navigation input device (210), and a speaker (212). The display is located in-between the rotary input device and the navigation input device. The speaker is disposed inside or adjacent to the navigation input device. An audio passage (228) is adjacent to or extending through the navigation input device and adjacent to the speaker. The apparatus can be configured in a substantially horizontal configuration (200) or a substantially vertical configuration (400). The information presented on the display changes orientation depending on the configuration of the apparatus.

### FIELD OF THE INVENTION

The present invention relates generally to user interfaces of portable electronic apparatus, and more particularly to a multifunctional user interface for such an apparatus.

### BACKGROUND OF THE INVENTION

Portable electronic apparatus, such as wireless handsets, may incorporate multiple functions that are selectable or controllable by the user via the user interface. With a single mode apparatus, such as a radiotelephone, the user interface is optimized for use as a radiotelephone. Portable electronic apparatus however are taking on more and more capability and as a result, the user interface must also take on more capability. The complexity of the user interface increases as the number of the functions increases. For example wireless communication apparatus emerging on the market today may function as a radiotelephone, a personal digital assistance (PDA), a gaming apparatus, or a messaging, pictorial or video console, or any combination thereof. Navigation to or within one or more of the modes, functions, menus, or games of the apparatus can take the user through a large number of steps and key presses to get to the desired function as the number of operations available increases. At the same time, miniaturization of the apparatus is also desired to maintain and promote portability. This results in reduced space for the increasingly complex user interface.

An additional challenge arises because the user interface that is optimized for one operating mode may not necessarily be optimized for another operating mode. For example, the user interface devices necessary for a radiotelephone are not the same as those for a gaming apparatus. Combining a traditional 12 key keypad of a radiotelephone with motion control inputs and action buttons for gaming produces a complex user interface. Often, the solution is to assign multiple functions to one key or button, adding complex indicia. This however is contrary to the desire for small size and reduced operating complexity for the apparatus.

Another method of simplifying the ease of use of multifunctional apparatus is to assign menu short cut buttons. For instance, electronic organizers use menu shortcut buttons on the front of the apparatus to gain quick access to different frequently accessed menus or functions. However this takes up space on the housing and such buttons are physically non-configurable.

Accordingly, what is needed is an easy to use apparatus having multiple functions, menus or operations and enhanced capability for different modes while reducing complexity of portable apparatus such as wireless communication apparatus.

### BRIEF DESCRIPTION OF THE DRAWINGS

The various aspects, features and advantages of the present invention will become more fully apparent to those having ordinary skill in the art upon careful consideration of the following Detailed Description with the accompanying drawings described below.

FIG. 1 is an exemplary block diagram of a wireless communication handset circuit;

FIG. 2 is an exemplary view of the wireless communication apparatus;

FIG. 3 is an exemplary view of the wireless communication apparatus;

FIG. 4 is an exemplary view of the wireless communication apparatus;

FIG. 5 is an exemplary cross section of the input device of the wireless communication apparatus;

FIG. 6 is an exemplary keypad of the wireless communication apparatus;

FIG. 7 is an exemplary view of a rotation sensor;

FIG. 8 is an exemplary view of a rotary input device and rotation sensor;

FIG. 9 is an exemplary one-bit rotary encoder and corresponding digital encoder output diagram;

FIG. 10 is a top down exemplary view of the rotary input device having a first exemplary rotary encoder;

FIG. 11 is a section view of a portion of the rotary input device;

FIG. 12 is a first exemplary pull-down circuit; and

FIG. 13 is a second exemplary pull-down circuit.

### DETAILED DESCRIPTION OF THE DRAWINGS

The present invention is a portable electronic apparatus that has multiple user interface devices that are embodied in an adaptable configuration that provides ease of use and reduced complexity through multiple configurations optimized for different modes of operation. The apparatus may be a multifunction apparatus wherein a combination of operation modes are possible including; a gaming apparatus with a cellular radiotelephone, a cellular radiotelephone with a data assistant or any combination of a number of functionalities including, messaging, internet browsing, personal organizer, business organizer, personal digital assistant capabilities, or the like. Although not required these portable handheld apparatus are often arranged and constructed to operate on communication systems such as 3G, GPRS (General Packet Radio System) systems, Enhanced Data Rates GSM Evolution (EDGE) or wideband CDMA (WCDMA) systems or systems that are packet data enabled and that enable connectivity or sessions with IP (Internet Protocol) based networks, including for example packet data based systems such as 3^{rd} generation or UMTS (Universal Mobile Telephone Services) systems. These apparatus may also function in either the circuit switched domain or the packet switched domain, or both.

The portable electronic communication apparatus includes a housing that is configured for use in at least one orientation. The housing includes electronic circuitry, a keypad, a first input device, a rotary input device, a display, a second input device and a speaker. Optionally a microphone is included. The first input device comprises at least a portion of the keypad. The second input device is adjacent to the speaker and may overlay the speaker. The speaker may be enclosed in the second input device. Audio signals from the speaker are directed outside of the housing by porting the signals through a sound passage in the housing or the second input device. The display is located on a front surface of the housing between the first input device and the second input device. In one exemplary embodiment, the user interface devices are in a substantially linear arrangement. The first, second and rotary input devices together with the display, speaker and microphone, form the user interface for the communication apparatus.

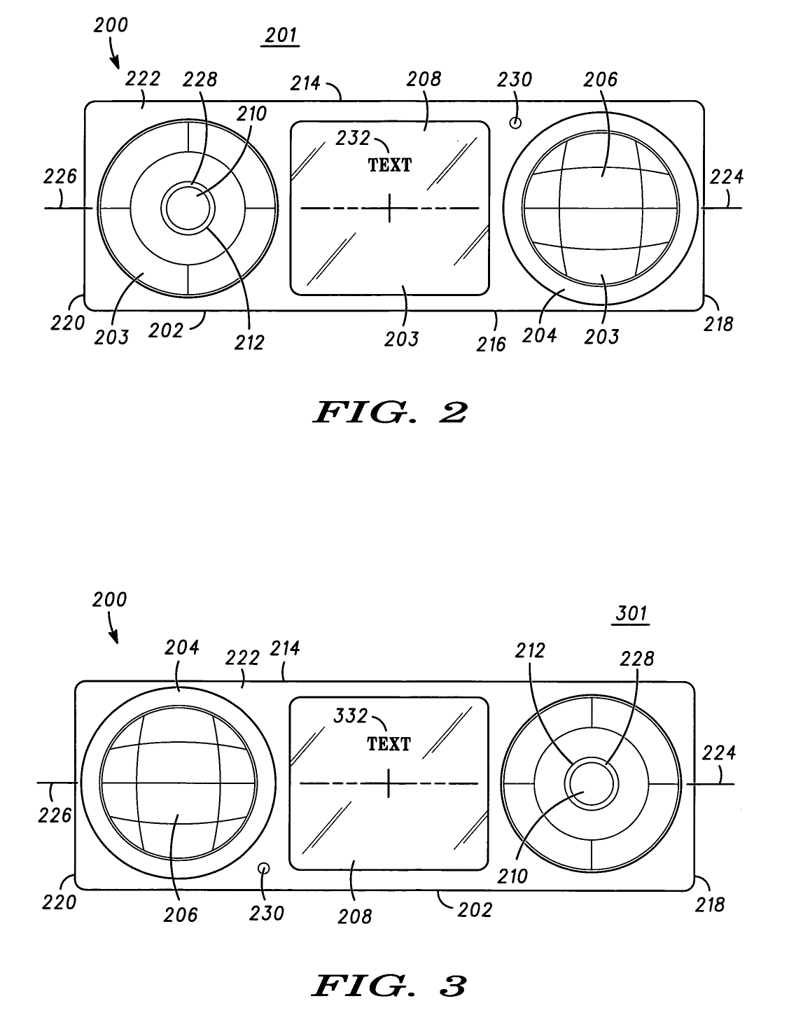

A portable apparatus 200 is illustrated as a wireless communication apparatus. The exemplary portable communication apparatus in FIG. 2 is illustrated in a first horizontal configuration 201, with the input devices arranged to the sides of the display, which is in contrast to cellular handsets which are typically arranged for a vertical configuration with the display above the keypad. The wireless communication apparatus 200 has wireless communication capabilities and thus, may be used to communicate with a cordless telephone base, a wide area network (WAN) wireless infrastructure, such as cellular base stations, and/or wireless local area networks (WLAN), such as 802.11 routers or access points. The wireless communication apparatus 200 described herein is an example of the type of wireless communication apparatus that will benefit from the user interface improvements set forth herein. However, it is to be understood that the user interface improvements may be applied to any type of portable electronic apparatus and is not limited to radiotelephones, such other apparatus including gaming apparatus, paging apparatus, personal digital assistants, electronic organizers, portable computers, handheld computers, pen-based or keyboard-based handheld apparatus, remote control units, audio or video players (such as MP3 or MPEG players) and the like.

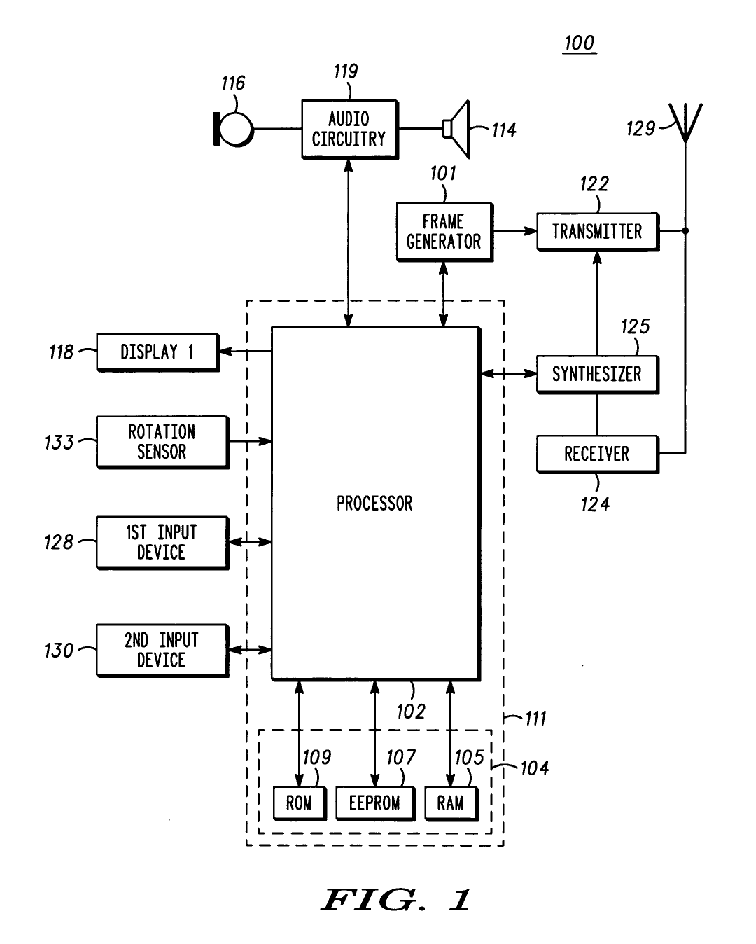

Exemplary circuitry 100 for the illustrated wireless communication apparatus 200 is illustrated in FIG. 1, and more particularly exemplifies a multifunctional cellular handset. The circuitry 100 includes a frame generator ASIC 101 and a microprocessor or controller 102 that combine to generate the necessary communication protocol for operating in a wireless communication system. Controller 102 uses memory 104 comprising random access memory (RAM) 105, electronically erasable programmable read only memory (EEPROM) 107, and read only memory (ROM) 109, preferably consolidated in one package 111, to execute the steps necessary to generate the protocol and to perform other functions for the wireless communication apparatus, such as writing to a user interface or display 118, accepting input from a rotation or position detector 133, first input device 128 and second input device 130, or other components associated with the wireless communication apparatus. The controller 102 may be implemented using a microcontroller, a microprocessor, a digital signal processor (DSP), programmable logic, discrete logic, or the like, or a combination thereof. The controller 102 also controls a transmitter 122, a synthesizer 125, and a receiver 124 for transmitting and receiving communications, and optionally software for the user interface devices. ASIC 101 processes audio signals to be transformed by audio circuitry 119 for input to speaker 114, and audio signals from a microphone 116 after being transformed by audio circuitry 119. The circuitry 100 is described herein for illustrative purposes only, and it will be recognized that the communication apparatus may house these or other circuitry, as the circuitry is not essential to the invention as defined by the claims.

The communication apparatus 200 of the exemplary embodiment as shown in FIG. 2 includes a housing 202 for the electrical circuitry 100. The communication apparatus 200 includes a user interface 203 with the following user portions: a first input device 204, a keypad 206, a display 208, a second input device 210, and a speaker 212. The display 208 is located between the first input device 204 and the second input device 210. The arrangement of the user interface devices in one exemplary configuration is a horizontal configuration 201. This configuration may be referred to as a landscape or horizontal orientation as it is conducive to gaming applications where the user comfortably holds the handset with both hands and the user portions of the user interface devices 203 are horizontally arranged.

In this exemplary embodiment, the housing 202 has a top 214, a bottom 216, a first side 218, a second side 220, a front 222 and a back 224. In the embodiment shown in FIG. 2 the housing 202 is an elongated housing such that the top 214 and the bottom 216 are longer than the first side 218 and the second side 220. The sides can be any proportional length but is illustrated having a rectangular shape as an exemplary embodiment which is configured for holding in one hand to facilitate audio communication via a speaker and microphone. Alternative configurations are envisioned, for example the top 214, bottom 216, the right side 218 and the left side 220 may all be equal providing a square shape. Regardless of the configuration, the first input device 204, the display 208, and the second input device 210 are arranged along a longitudinal dimension of the housing, and may for example be arranged linearly along a longitudinal axis 226 of the housing 202. It is envisioned that should the housing 202 alternatively be circular, ovular or asymmetric in shape (such as a polygon), the first input device 204, the display 208 and the second input device 210 may still be substantially horizontally arranged on a surface of the housing.

The user portions of the user interface 203 are arranged linearly as shown in FIG. 2 from left to right starting with the second input device 210 adjacent to the first side 220, which is the left side in this exemplary embodiment. Adjacent to the second input device 210, located to the right thereof, is the display 208. Located to the right of the display 208, and adjacent thereto, is the keypad 206. Encompassing the keypad 206 is the first input device 204. The illustrated form of the housing 202 in the exemplary embodiment is a single housing elongated form having dimensions comfortable to hold in one hand while entering a telephone number or to hold against the users head during a conversation with the speaker and microphone positioned for good verbal communication. The keypad 206, display 208 and the second input device 210 are aligned substantially in a row centered on an axis 224 running through the user interface devices. The axis 224 of the keypad, display and second input device is aligned substantially parallel to the longitudinal axis 226 of the elongated housing, and may optionally be the same axis.

The housing 202 may be rounded on the ends such that it is more comfortable for the user to hold, or it may be square to facilitate assembly and minimize dimensions. When the user holds the handset 200, and the handset is operative in the first horizontal configuration 210, the user interface devices are arranged as described above. The user holds the handset 202 with two hands as is done with current game controllers or consoles. In such orientation, the first input device 204 and the keypad 206 are accessible to digits of the first hand and the second input device 210 is accessible to the digits of the second hand.

It should be noted however that the linear arrangement can be reversed such that the second input device 210 and the speaker 212 are on the right side 218 of the apparatus and the first input device 204 and the keypad 206 are on the left side 220 of the apparatus. This is illustrated in FIG. 3, wherein the handset 200 is shown in an exemplary reverse horizontal configuration 301 (also referred to herein as the second horizontal configuration). The handset 200 is shown with the second input device 210 adjacent to the right side 218 of the housing 202. Adjacent to the navigation input device 210, located substantially to the left thereof, is the display 208. Located to the left of the display 208, and adjacent thereto, is the keypad 206. The keypad is adjacent to the left side 220. Encompassing the keypad 206 is the first input device 204.

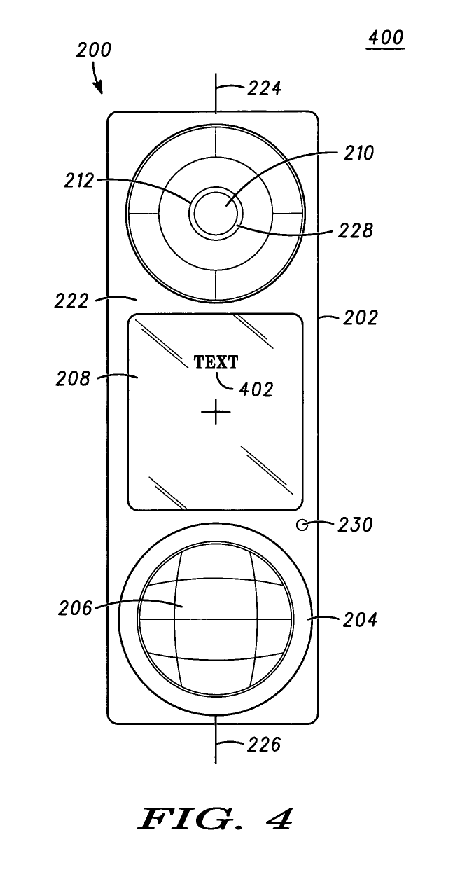

FIG. 4 shows the handset 200 in the vertical configuration 400 such that the second input device 210 is arranged above the display 208. In this orientation, the labels associated with the keys are oriented for reading and dialing when the display is above the keypad 206. The speaker 212, which is adjacent to the second input device 210 can be placed adjacent to the user's ear for use in a radiotelephone mode. The information on the display 208 is presented in a vertical information orientation 402, or portrait configuration. The optional microphone 230 is located at an end of the housing, distal to the speaker 212 such that it is near the user's mouth.

The display 208 located between the first input device 204 and the second user interface 210 allows the user to hold the apparatus in the horizontal configuration 201, operate the first input device 204 and the second input device 210 with each hand, while the display remains visible to the user. Alternatively, the user can rotate the apparatus to the vertical configuration 400 and operate the apparatus as a radiotelephone having the display 208 information readable in a vertical information orientation 402 and the speaker 212 for placement over the user's ear.

The display 208, illustrated in FIGS. 2, 3 and 4 is placed adjacent to and in-between the first input device 204 and keypad 206 and the second input device 210 and speaker 212. The display 208 can be a black and white display or a color display. The current trend is to incorporate color displays into radiotelephone apparatus, which is advantageous as the gaming experience is typically enhanced by the use of colors. The display 208 may be a touch screen which may further enhance the adaptability of the user interface by allowing for soft keys and buttons to be configured on the touch screen as well as potentially providing handwriting recognition capability. The display 208 may be any suitable commercially available display that provides a convenient display of text, images and/or graphics to the user. For example, the display 208 may be implemented using a liquid crystal display having a backlighting system to illuminate the display when ambient lighting conditions are insufficient for proper viewing by the user. A lens (not shown) may be provided that holds certain components of the handset 200 in an assembled state and protects the display 208 from undesirable, foreign matter. The first input device 204, keypad 206 or the second input device 210 may control information on the display 208.

The information on the display 208 can change in accordance with the orientation of the handset 200. In the horizontal configuration 201, the information on the display 208 is in a first horizontal information orientation 232. In the reverse configuration 301, the information on the display 208 is in a second horizontal information orientation 302. In this exemplary orientation the information is rotated 180 degrees from the first horizontal information orientation 232. In the vertical configuration 400, the information on the display 208 is in a first vertical information orientation 402, which in the preferred embodiment is rotated 90 degrees relative to the first horizontal information orientation 232. The handset 200, in the vertical configuration 400, places the display in a portrait orientation in the exemplary embodiment shown in FIG. 4. The display 208 may be square, rectangular or any other shape that may be accommodated by the housing 202.

The orientation of the information on the display can be changed automatically, such that as the handset 200 is rotated from the horizontal configuration 201 to the vertical configuration 400, the information on the display 208 rotates or changes orientation such that it is readable or understandable to the user, such as in the first horizontal information orientation 232, second horizontal information orientation 332, for example. The information orientation on the display 208 may also be configured manually on the display by the user though optional buttons on the handset or through soft buttons on the display 208.

Referring back to FIG. 2, the first input device 204 surrounds the keypad 206. In one exemplary embodiment the first input device 204 is a ring that completely encompasses the keypad 206. In this embodiment, the ring is a rotary input device 204, which physically rotates in clockwise and counter clockwise directions. The rotary input device 204 may be used to move a cursor across the display 208, scroll through menus, to steer a vehicle, person or weapon in a gaming mode, control the zoom function on a camera or focus operation on a camera, tune a radio, audio equalizer adjustment, map navigation, in conjunction with music mixing functions. Although it is envisioned that the rotary input device 204 will preferably rotate freely in either direction without any stops, it can alternatively move in only one direction or it may rotate through a 360 degree or smaller arc set by respective stops. The rotary input device 204 may also have detents such that the ring is restrained at desired positions, and does not move without some minimum force being applied to get past the detents. Such detents will provide tactile feedback to the user scrolling though a menu and will help prevent accidental changing of the mode or function that would otherwise occur due to unwanted rotation.

The rotary input device 204 may have a plurality of indicia (not shown) disposed thereon. For example, where the rotary input device 204 is a mode selector ring, it will be rotated relative to the housing 202 to move a desired one of the indicia on the rotary input device 204 corresponding to a desired mode into alignment with an indictor on the housing to select the operating mode. In one exemplary embodiment the rotary input device 204 is removably coupled to the housing 202. The rotary input device 204 may be interchanged with a different rotary input devices, having different colors, different indicia thereon or different icons or looks. The indicia may be a simple mark or arrow that denotes positions of the rotary input device 204.

It is envisioned that the rotary input device 204, need not rotate to effectuate a rotary input operation. The rotary input device 204 may be a touch sensitive input device operative to sense the user's digit as it moves on a surface. For example, the device may be any suitable commercially available planar sensor, such as a capacitive or resistive touch pad. The rotary input device does not physically rotate in this embodiment as it does in the previous embodiment. This allows the rotary input device 204 to take different shapes, and to be implemented using a device with non-moving parts. The shape of the first input device 204 may be circular (such as a ring like an O), the shape of an oval or a square that surrounds or encompasses the keypad 206. The first input device 204 may alternatively be an in the shape of a C or U-shaped such that it only partially surround the keypad 206.

The second input device 210 can be a single button, multiple buttons, or a multidirectional input device, such as a joystick (or other navigation input device), or the like. In one embodiment, the multidirectional input device 500 includes a multidirectional button or set of buttons (not shown) and in another embodiment the multidirectional input device 500 includes a handle 502. The multidirectional button is depressible in a plurality of directions. The multidirectional button may be comprised of several buttons arranged in a cluster. For example, the multidirectional button may be comprised of four buttons arranged in substantially a square such that each button of the four buttons controls an independent function such as up, down, left and right.

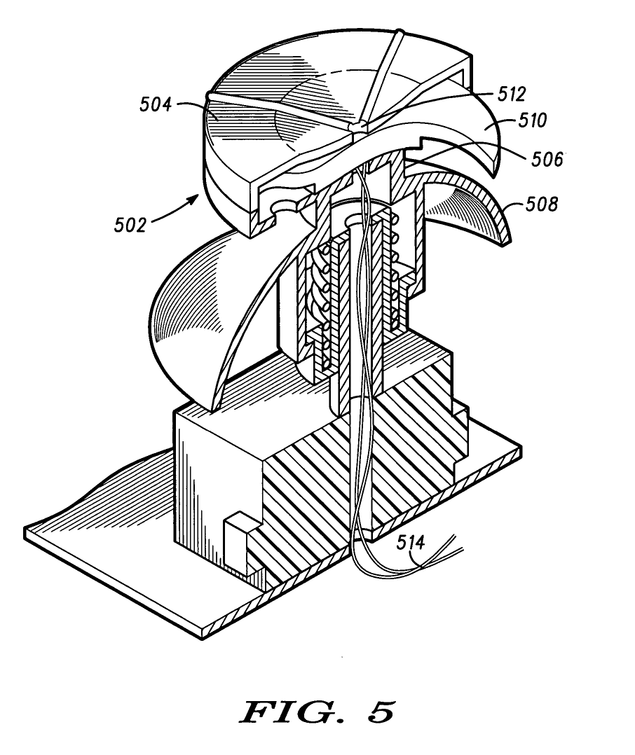

FIG. 5 illustrates the second input device 210 as a multidirectional input device 500 having a handle 502. The multidirectional input device 502 includes a handle 502, similar to a joystick. The handle 502 is moved to control direction of information on the display 208. The multidirectional input device that includes a handle 502 may optionally comprise a knob 504. The knob 504 can be moved in a plurality of directions. The knob 504 may be comprised of a neck 506, which in turn is connected to a skirt 508. As one skilled in the art appreciates, there are many input devices that operate as multidirectional input devices.

In one embodiment, the speaker 212 is disposed in the housing 202 adjacent to the second input device 210. The speaker is adjacent to an audio passage 228, which extends through the housing 202 or extends through the second input device 210. The audio passage 228 may be a cylindrical void or a gap between the second input device 210 and the front 222 of the housing 202 which allows the audio to pass from the speaker 212 to the outside of the housing 202. The speaker 212 may optionally be ported with other audio passages to create the desired acoustics. In another exemplary embodiment shown in FIG.5, the speaker is disposed in the second input device. In this embodiment, the speaker 510 is disposed in the knob 504. A port 512 in the knob 504 is an audio passage that allows the sound from the speaker 510 to pass out of the knob 504. The speaker 510 is also adjacent to the neck 506 in this embodiment. Speaker wires 514 are routed through the neck 506 and out of the multidirectional input device 500.

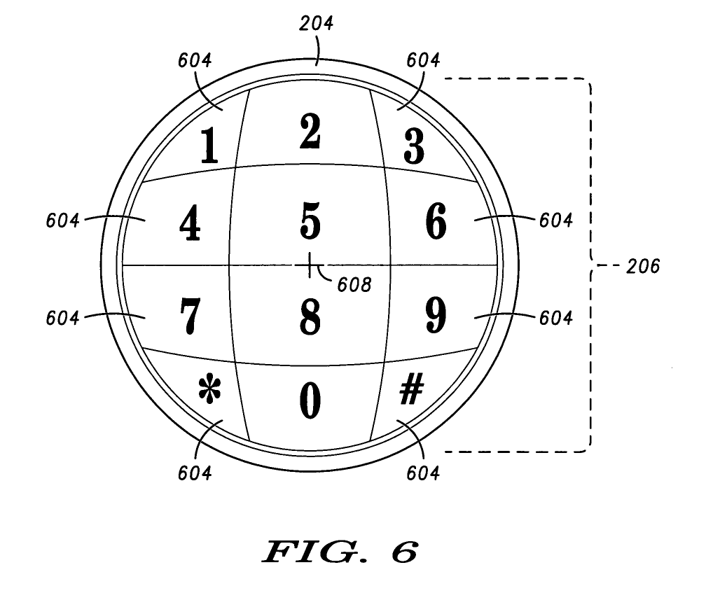

FIG. 6 shows the keypad 206 encompassed by the first input device 204. The keypad 206 may be a single key or a plurality of keys 602. The plurality of keys may be a traditional bell keypad which includes the numbers 0-9 and optionally the # and * keys. The plurality of keys may include an outer set of keys 604 that form a complimentary shape to the first input device 204. For example, if the first input device 204 is in the shape of a ring, the outer set of keys 604 form a circle inside of and adjacent to the first input device 204. The keypad 206 may optionally be a rotating keypad that mechanically rotates about a center axis 608 to align in accordance with the different apparatus configurations, i.e. the first or second horizontal configuration 201, 301 or the vertical configuration 400. The keypad rotates between a first keypad orientation when said apparatus is in the horizontal configuration 201, and a second keypad orientation when said apparatus is in the vertical configuration 400, and a third keypad orientation for use in the second horizontal orientation.

The keypad 206 may also be a touch sensitive device such as a touch screen display. This would allow the keypad 206 to be configured in accordance with the function, mode, and orientations of the apparatus. The orientation of the plurality of keys or the information displayed on the touch screen display may be rotated to align with the apparatus configurations, i.e. the first or second horizontal configuration 201, 301 or the vertical configuration 400.

It will be recognized that the communication apparatus 200 need not include the ability to change orientation. In other words, an advantageous communication apparatus may be achieved having only a single user orientation for the display and keypad labels. In such an apparatus, the first and second input devices will provide a favorable user experience in gaming, telephony, as well as other functions.

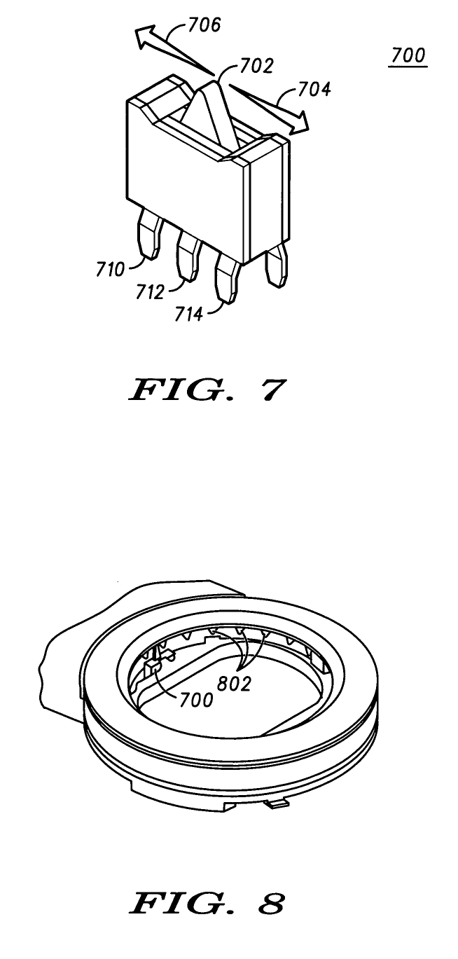

Moving to FIG. 7 and in reference to FIGS. 2, 3 and 4, the rotary input device is coupled to the position sensor 133. In the exemplary embodiment wherein the rotary input device 204 mechanically rotates, the rotation is sensed by the position or rotation sensor 133. The position sensor 133 may be one of many types of sensors or detectors used to determine rotational movement and position. Converting the mechanical rotational motion of both the rotary input device 204 into electrical signals that are sent to the processor 103 is done with switches or sensors coupled to the either of the user interfaces, mechanically or optically, and the first housing portion 202. In FIG. 7 a switch 700 is shown. This switch 700 is a detector switch, such as an ESE 23 or ESE 24 from Panasonic. The switch lever 702 is in a normally open position when the housing is in a first, or stationary, position. The switch lever 702 can move in two directions, a first direction 704 and a second direction 706. The switch lever 702 is spring loaded such that a force applied in either direction moves the switch lever 702 and when the force is removed from the switch lever 702, the switch lever 702 will spring back to the first or stationary position.

When the switch lever 702 is moved in the first direction 704, a first circuit between the contacts 710 and 712 is complete or closed and when the switch lever 702 is moved in the second direction 706, a second circuit between the contacts 714 and 712 is completed or closed.

This switch 700 is coupled to the housing 202 as shown in FIG. 8. The switch lever 702 is position such that it will selectively couple with actuators or teeth 802 which are coupled to the rotary input device 204. The teeth 802 rotate with the rotary input device as it rotates, the teeth 802 selectively couple to the switch lever 702 and depending on the direction of rotation, move the lever in either the first direction 704 or the second direction 706. When the ring 204 is rotated, a first actuator couples with the switch lever 702 and moves the switch lever in the first direction 704. The circuit between 710 and 712 is closed and a signal is sent to the microprocessor 103. The microprocessor 103 generates the command to indicate the position of the rotary input device 204. When the rotary input device 204 is rotated to position, illustrated by arrow 714, a second actuator couples with the switch lever 702 and moves the switch lever 702 in the second direction 706. The circuit between 710 and 712 is closed and a signal is sent to the processor 102. The processor generates the command to indicate movement on the rotary input device 204.

In the case of the freely rotary input device 204, a plurality of teeth 802 are selectively coupled to the rotary input device 204 as the rotary input device, or ring, 204 rotates in either direction. Each time a tooth couples with said switch lever 702, the switch lever 702 is moved in the first or second direction, depending upon the rotation direction of the rotary input device 204, and either the first circuit or second circuit is closed. Rotating the rotary input device 204 in one direction allows a plurality of teeth to selectively couple to the switch lever and repeatedly move the switch lever 702 in the same direction. The affect is the tracking of the position of the rotary input device 204 relative to the housing 202.

The relative positions of the rotary input device 204 may also be detected by a rotary encoder having a first encoder portion coupled to the rotary input device 204 and a relatively fixed encoder portion coupled to the housing 202.

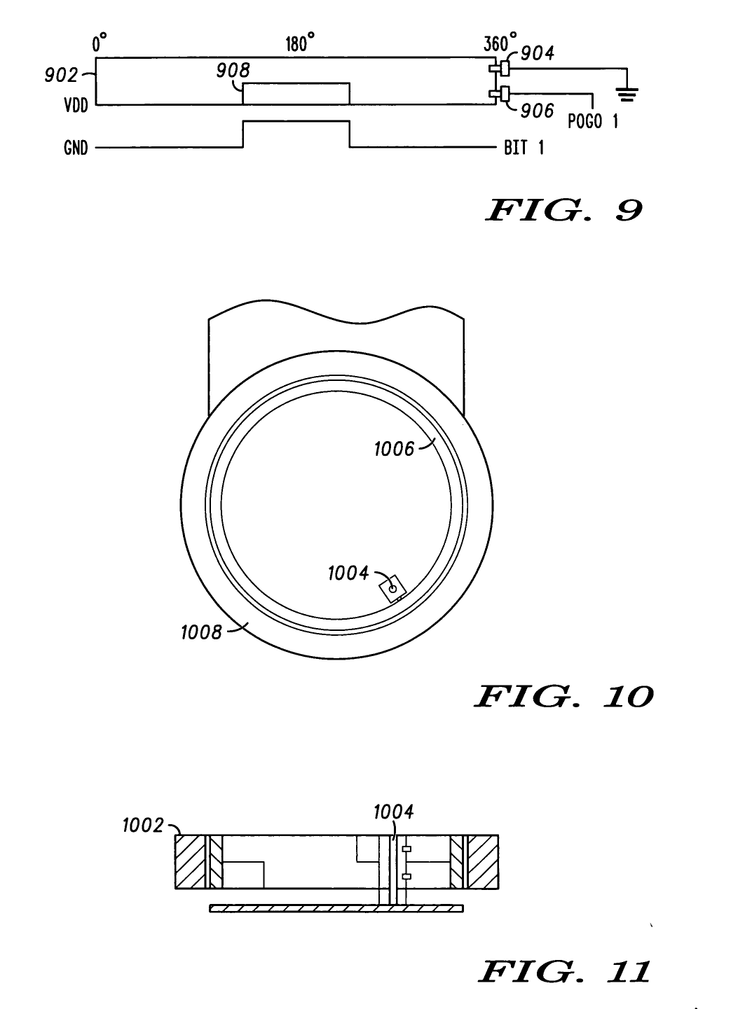

FIG. 9 illustrates a first exemplary rotary encoder embodiment comprising a partially conductive strip 902 with bit patterns formed thereon 908. The strip 902 is formed into a ring and fastened to rotary input device 204. At least two conductors, for example, pogo pins 904 and 906, are coupled to the housing 202 so that the pins are in contact with the conductive strip 902.

In FIGS. 10 and 11, the conductive strip 902 is disposed on an inner surface of the rotary input device 204 in the exemplary embodiment. Alternatively, the bit pattern 908 may be formed directly on the surface of the rotary input device 204, for example by depositing conductive and non-conductive materials thereon. FIG. 10 illustrates a pogo pin mounting assembly 1004 mounted on an inner ring 1006 of the housing 202, and FIG. 11 illustrates the pogo pin mounting assembly 1104 disposed on a circuit board 1106.

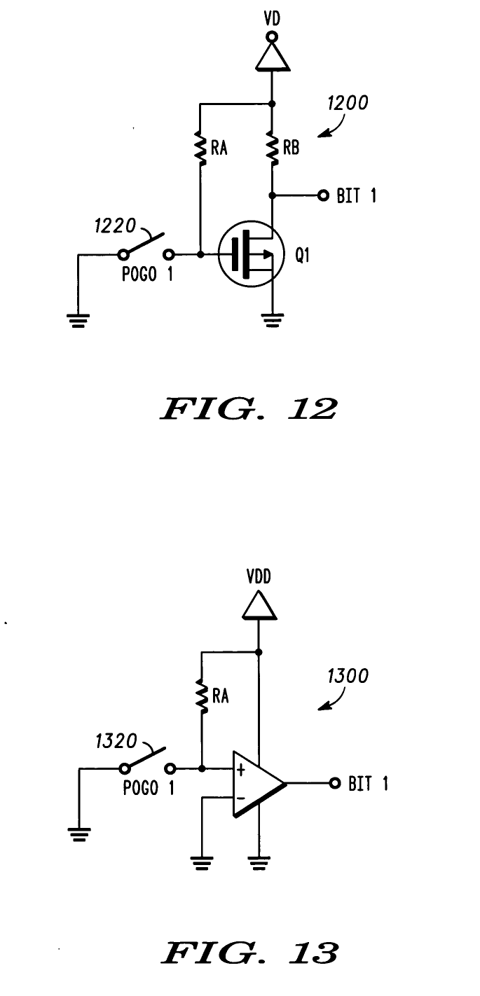

The conductors of the rotary encoder are coupled to an electrical circuit that detects when an electrical connection between the conductors is made and broken by conductive and non-conductive portions of the strip. FIGS. 12 and 13 illustrate exemplary voltage pull-down circuits 1200 and 1300, respectively, with corresponding switches 1220 and 1320 representative of the contact made between the conductors of the rotary encoder. The generation of electrical connections is then sent to the microprocessor 103. The microprocessor 103 interprets the input signals from the rotary encoder and sends commands to the display to move the information thereon accordingly.

In operation, the user interface devices send information to and receive information from the controller 102 wherein each input device may have a different function or control a different operation depending on the operation mode of the device. It is envisioned that in an exemplary gaming mode, the first input device 204 is a rotary input device and operates as a steering wheel to control a vehicle which is presented on the display 208. The keypad 206, may be used to select gears or views, or a combination thereof, displayed on the display 208 to the user. Each key of the keypad 206 may be assigned an individual function such as one key to start the game, another key to end the game, and another key to pause the game. The second input device 210 may be used to control the acceleration and braking of the vehicle displayed on the display 208.

In the exemplary gaming mode, the user holds the apparatus with two hands; the right hand grasps the right side of the apparatus such that user's right thumb operates the first input device 204. The user's left hand grasps the left side of the apparatus such that user's left thumb operates the second input device 210. This allows the user to steer the vehicle on the display 208 with the right thumb and apply acceleration and braking with the left thumb. The arrangement of the keypad 206 and the first input device 204, allow the user to actuate either user interface from the same hand, the right hand in this exemplary embodiment. The user may use the right thumb to control both the first input device 204 and the keypad 206 or two different digits from the right hand. For example while steering the vehicle the user can move the thumb from the first user interface to depress a key on the keypad 206 to select the desired gear. The display 208 is unobstructed and remains viewable to the user free of interference by the user's hands.

It is envisioned that in an exemplary messaging mode, the first input device 204 is a rotary input device and operates to scroll information such as message lists or the message text which is presented on the display 208. The keypad 206 may be used to select character as for typing a message which is presented on the display 208. Each key of the keypad 206 may be assigned an individual alphanumeric character. The second input device 210 may be used to control whether the alphanumeric character selected is an upper case or a lower case character or to select from multiple characters assigned to one key of the keypad 206. In addition the second input device 210 may be used to control the position of the cursor relative to the text. For example, moving the second user interface left or right moves the cursor left and right as in a word processing mode.

In the exemplary messaging mode, the user holds the apparatus with two hands, similarly as with the gaming mode. The right hand grasps the right side of the apparatus such that user's right thumb operates the first input device 204. The user's left hand grasps the left side of the apparatus such that user's left thumb operates the second input device 210. This allows the user to enter text with both hands, which increases the ease and speed of text input. The second input device 210 may be used to control the function of the first input device 204. For example, actuating the second input device may change the operation of the first input from a scrolling operation to a volume control operation. Of course this is only one example and other combinations of the interaction between the input devices can be envisioned.

In an exemplary radiotelephone mode, the first input device 204 may be used to control the speaker volume or microphone volume in when a voice call is in progress. The first user interface may also be used to scroll through a phone book when the apparatus is in phone book mode. The keypad is used to dial or input a number or information associated with a number and as in text mode, the information can be input by a combination of the first input device 204 and the second input device 210.

Although gaming, messaging and radiotelephone modes of the apparatus are disclosed for exemplary purposes, it is understood that other modes of operation are envisioned wherein the input devices are used in the configuration disclosed.

While this invention has been described with specific embodiments thereof, it is evident that many alternatives, modifications, and variations will be apparent to those skilled in the art. For example, various components of the embodiments may be interchanged, added, or substituted in the other embodiments. It is envisioned that the first input device may be implemented using a rotary device circumscribing the keypad and the second input device can be a rotary device circumscribing the speaker to provide a balanced user input. Alternatively, the second input device can be a joy stick adjacent the speaker port and the first input device can be a joy stick positioned in or adjacent the keys of the keypad. Accordingly, the embodiments of the invention set forth herein are intended to be illustrative, not limiting. Various changes may be made without departing from the spirit and scope of the invention.

1. A handheld wireless communication apparatus comprising:
a housing;
a first input device carried on said housing;
a rotary input device carried on said housing and adjacent to and encircling said first input device;
a second input device carried on said housing;
a display carried on said housing substantially in-between said rotary input device and said second input device; and
a speaker carried in said housing adjacent to said second input device.

2. The apparatus of claim 1, wherein said housing is an elongated housing, having a long dimension and a short dimension.

3. The apparatus of claim 2, wherein said rotary input device, said display, and said second input device are aligned substantially linearly along said long dimension of said elongated housing.

4. The apparatus of claim 1, wherein said rotary input device, said display, and said second input device are aligned substantially linearly.

5. The apparatus of claim 4, wherein said display is adjacent to said rotary input device and adjacent to said second input device such that said display is arranged substantially in-between said rotary input device and said input device.

6. The apparatus of claim 5, wherein said first input device is a keypad.

7. The apparatus of claim 6, wherein said keypad includes a plurality of keys, wherein an outer set of keys of said plurality of keys include an arcuate outer edge such that at least a portion of a perimeter of said keypad is in the shape of a circle.

8. The apparatus of claim 7, wherein said rotary input device encompasses said plurality of keys, such that said outer set of said keys are adjacent to said rotary input device.

9. The apparatus of claim 8, wherein said rotary input device rotates around said keypad.

10. The apparatus of claim 8, wherein said rotary input device is a circular capacitive sensor.

11. The apparatus of claim 8, wherein said second input device includes an audio passage coupled to said speaker.

12. The apparatus of claim 11, wherein said speaker is disposed in said second input device.

13. The apparatus of claim 14, wherein said input device is a multidirectional input device.

14. The apparatus of claim 13, wherein said multidirectional input device is a navigation input device.

15. The apparatus of claim 1, further comprising a microphone disposed in said housing.

16. The apparatus of claim 15, wherein said microphone is disposed at an end of said housing distal from said speaker.

17. The apparatus of claim 15, wherein said microphone is disposed in said housing substantially adjacent to said keypad.

18. The apparatus of claim 1, wherein said apparatus is configured in a horizontal configuration such that said rotary input device, said display, and said second input device are aligned substantially linearly and arranged horizontally, wherein information on said display, said first input device and said second input device are in a horizontal information orientation.

19. The apparatus of claim 1, wherein said apparatus is configured in a vertical configuration such that said rotary input device, said display, and said second input device are aligned substantially linearly and vertically, wherein information on said display, said first input device and said second input device are in a vertical information orientation.

20. A wireless communication apparatus comprising:
an elongated housing adapted to be held in a horizontal configuration and a vertical configuration;
a keypad carried on said housing having a plurality of keys;
a first input device carried on said housing adjacent to said keypad and at least partially circumscribing said keypad;
a second input device carried on said housing;
an audio passage carried on said housing adjacent to said second input device;
a speaker carried in said housing and acoustically coupled to said audio passage; and
a display carried on said housing, said display disposed between said keypad and said second input device such that said keypad, said display and said second input device are oriented in a horizontal configuration.

21. The apparatus of claim 20, wherein said keypad, said display and said second input device are oriented along a longitudinal axis of said elongated housing.

22. The apparatus of claim 20, further comprising a microphone.

23. The apparatus of claim 20, wherein said first input device encompasses said keypad.

24. The apparatus of claim 20, wherein said display presents information in a first information orientation when said apparatus is in said horizontal configuration, and wherein said display presents information in a second information orientation when said apparatus is in a vertical configuration.

25. The apparatus of claim 20, wherein said at least one button is readable in said horizontal configuration and said at least one button is readable in said vertical configuration.

26. The apparatus of claim 20, wherein said speaker is disposed in said input device.

27. The apparatus of claim 24, wherein said keypad rotates to a first keypad orientation when said apparatus is in said horizontal configuration, and
wherein said keypad rotates to a second keypad orientation for said apparatus in said vertical configuration.

28. A wireless communication apparatus comprising:
an elongated housing having a front surface, a first end and a second end; a transceiver carried in said housing;
a controller carried in said housing, said controller coupled to said transceiver;
a microphone carried in said housing;
a multi-key keypad carried on said front surface of said elongated housing adjacent said first end of said housing, said multi-key keypad coupled to said controller;
a speaker port on said front surface of said housing, said speaker port adjacent said second end of said housing;
a speaker navigation input located at the speaker port, the speaker navigation input coupled to the controller;
a rotating input circumscribing said multi-key keypad, the rotating input coupled to said controller; and
a display carried on the housing between said rotating input and said speaker port, said display coupled to said controller.
